(19) United States
(12) Patent Application Publication
(10) Pub. No.: US 2025/0198917 A1
(43) Pub. Date: Jun. 19, 2025

(54) SPECTROMETRIC MEASURING METHOD AND MEASURING DEVICE FOR PERFORMING A SPECTROMETRIC MEASURING METHOD

(71) Applicant: Endress+Hauser Conducta GmbH+Co. KG, Gerlingen (DE)

(72) Inventors: Felicia Seichter, Ludwigsburg (DE); Andreas Bayer, Gerlingen (DE); Thilo Krätschmer, Gerlingen (DE)

(21) Appl. No.: 18/980,887

(22) Filed: Dec. 13, 2024

(30) Foreign Application Priority Data
Dec. 14, 2023 (DE) 10 2023 135 103.6

(51) Int. Cl. G01N 21/3577; G01N 21/33

(52) U.S. Cl. CPC G01N 21/3577; G01N 21/33

(57) ABSTRACT

The present disclosure relates to a spectrometric measuring method and device for measuring a parameter of a liquid medium in which interferences can occur that include bubbles and/or particles with dimensions larger than wavelengths within a measured wavelength range. In this process, measurement spectra are determined and those for which optical saturation has occurred are discarded. A medium spectrum is determined for each of the remaining measurement spectra. A check is then made to determine whether the measurement spectrum contains an offset caused by an interference by using a predetermined reference for a spectrum property that is expected in the absence of interferences. If an offset exists, the offset is subtracted from the corresponding measurement spectrum. Finally, the medium spectra are used to determine measured values of each measurement variable.

### CROSS-REFERENCE TO RELATED APPLICATION

The present application is related to and claims the priority benefit of German Patent Application No. 10 2023 135 103.6, filed on Dec. 14, 2023, the entire contents of which are incorporated herein by reference.

### TECHNICAL FIELD

The present disclosure relates to a spectrometric measuring method for determining at least one measurement variable of a liquid medium and to a measuring device that is designed to carry out the measuring method.

### BACKGROUND

Measuring devices for performing spectrometric measuring methods are used in a number of different types of applications, for example in wastewater treatment plants, in laundries, and in plants carrying drinking water, to measure different measurement variables.

These measuring devices usually comprise a spectrometric sensor having a spectrometric unit that, during measurement operation, receives measurement radiation resulting from interactions with the medium, such as absorption, reflection, and/or scattering, and uses the measurement radiation to determine measurement spectra, each of which reproduce spectral values for the measurement radiation in a predetermined measured wavelength range. These measurement spectra are provided to an evaluation apparatus that uses the measurement spectra to determine measured values for at least one measurement variable, such as a concentration of an analyte in the medium, for example a nitrite content and/or a nitrate content of the medium, a chemical or biological oxygen demand of the medium, and/or a degree of turbidity of the medium.

A number of applications have the problem that interferences that may occur in the medium at the application location, such as air or gas bubbles and/or larger particles, temporarily impair the quality of the measurement spectra. Air or gas bubbles can occur, for example, if compressed air cleaning is carried out at or near the spectrometric sensor. In addition, they can also be caused by turbulent flows of the medium flowing past the spectrometric sensor. The occurrence of air or gas bubbles usually has an immediate effect on the measurement spectra. This in turn results in a corresponding falsification of the measured values determined based upon the measurement spectra. Accordingly, certain measured values may sometimes have significant measurement errors as a result of measurement spectra affected by interferences. Similarly, impurities in the medium, such as macroscopic particles, such as small stones and/or lumps of sand, can also impair the quality of the measurement spectra and lead to correspondingly erroneous measurement values. Erroneous measured values are particularly problematic if the measured values are used to monitor, control, and/or regulate a property of the medium, a plant, and/or a process, such as a manufacturing process.

What is particularly problematic in this respect is that interferences such as air or gas bubbles and macroscopic particles naturally occur at unpredictable times and in each case only last for a short amount of time. In contrast to interfering analytes permanently contained in the medium, whose influence on the measurement spectra that interferes with the measurement can be at least partially compensated for by subtracting a reference spectrum of the interfering analyte, it is not readily possible to correspondingly compensate for disturbing influences that occur sporadically at unknown times for a short amount of time.

The adverse effects of interferences occurring in the medium on the measured value quality can be reduced, for example, by a method described in the German patent application filed on Dec. 17, 2022 with the file reference DE 102022130510.4. This method makes it possible to identify measurement spectra whose quality is impaired by interferences in the medium as outliers. This offers the advantage that the measurement spectra identified as outliers can be discarded and thus incorrect measurement values caused by outliers can be avoided. The disadvantage, however, is that no reliable measured values can be determined during the periods in which measurement spectra identified as outliers were recorded.

Another way to address this problem is to reduce the number of possible interferences by technical measures, such as bubble traps or particle filters, and/or a suitable selection of spectrometric sensor installation locations. However, this does not eliminate interferences in the medium and their adverse effects on the availability of reliable measured values.

JP 2012 093352 A describes a device having an optical or electrical bubble detector, which can be used to detect any bubbles that may occur in a liquid medium flowing through a supply line to an analyzer. When bubbles occur, the medium is supplied to a bubble removal channel via a switch, where the bubbles are removed by a bubble removal device. However, the use of corresponding devices is complex and associated with additional costs.

### SUMMARY

One object of the present disclosure is to provide a spectrometric measuring method that makes it possible to extend the measuring periods in which reliable measured values can be determined despite interferences occurring sporadically in the medium for limited periods of time.

For this purpose, the present disclosure comprises a spectrometric measuring method for measuring at least one measurement variable for a liquid medium in which interferences can occur, which include air bubbles, gas bubbles and/or particles whose dimensions are larger than wavelengths in a predetermined measured wavelength range, wherein:
a spectrometric sensor is used to continuously determine measurement spectra of the medium in the measured wavelength range,
those measurement spectra during the recording of which an optical saturation of the spectrometric sensor has occurred are identified and discarded,
a medium spectrum is determined for at least one of or for each remaining measurement spectrum by:
performing a verification method in which the particular measurement spectrum and a predetermined reference for a spectrum property that is expected in the absence of interferences within a predetermined spectral range, in which an absorption coefficient of the medium varies by less than a predetermined spectral variance depending on the wavelength and/or is below a predetermined limit value, are used to verify whether or not the particular measurement spectrum contains an offset caused by an interference that occurred in the medium when recording the particular measurement spectrum, and, if an offset exists, the size thereof is determined, and
the medium spectrum is determined such that it is equal to the measurement spectrum if the measurement spectrum does not contain an offset, and is equal to a difference spectrum determined by subtracting the offset from the measurement spectrum if the measurement spectrum contains an offset, and
the medium spectra are used to determine and provide measured values for the or each measurement variable.

The measuring method offers the advantage that all measurement spectra during the recording of which no optical saturation occurred are provided for determining the measured values for the measurement variable(s). The verification method offers the advantage that any interferences that may have occurred in the medium when recording the measurement spectra are detected thereby and their influence on the measurement spectra is accordingly compensated for by subtracting the offset. The latter offers the advantage that high measurement accuracy is achieved not only in the absence of interferences, but also in the presence of interferences.

This results in an extension of the measurement periods in which reliable measured values can be determined despite interferences occurring sporadically in the medium for limited periods. These measurement periods are only interrupted by those periods in which the effects of the interferences occurring in the medium are so significant that optical saturation occurs.

Another development is that the measured wavelength range comprises wavelengths in the ultraviolet range, the visual range and/or the near-infrared range, and/or wavelengths in a wavelength range from 190 nm to 2500 nm or in a section of this wavelength range, and
the spectral range comprises at least one wavelength in the visual range, at least one wavelength in the range of from 380 nm to 800 nm, at least one wavelength in the near-infrared range and/or at least one wavelength in the range of from 800 nm to 2500 nm.

A first variant provides that
the predetermined spectral range comprises a reference wavelength that lies within a subrange of the measured wavelength range,
the reference comprises a reference value for a spectral value that is expected in the absence of interferences in this reference wavelength, and the verification method comprises a first verification method, in which:
a difference between a spectral value of the particular measurement spectrum for the reference wavelength and the reference value is determined, and
the existence of an offset with a size corresponding to the value of the difference is established if the difference is greater than a predetermined tolerance.

Developments of the first variant consist in the fact that
a) the measured wavelength range comprises wavelengths in the ultraviolet and visual ranges or comprises wavelengths in the visual range, and the reference wavelength that lies within this measured wavelength range lies within a long-wave edge wavelength range of the measured wavelength range and/or is greater than or equal to 380 nm or greater than or equal to 500 nm, or
b) the measured wavelength range comprises wavelengths in the visual and/or near-infrared range, and the reference wavelength that lies within this measured wavelength range lies in a long-wave edge wavelength range, in a short-wave edge wavelength range or in a middle wavelength range of the measured wavelength range and/or is greater than or equal to 380 nm, greater than or equal to 500 nm, greater than or equal to 800 nm or is greater than 830 nm.

According to a further development of the first variant, the reference value expected in the reference wavelength is determined in advance on the basis of spectral values for reference spectra recorded in the reference wavelength by the spectrometric sensor in the absence of interferences.

A second variant consists in the fact that
the predetermined spectral range comprises a reference wavelength that is outside the measured wavelength range,
the reference comprises a reference value for a spectral value expected in the absence of interferences in the reference wavelengths that lie outside the measured wavelength range, and
the verification method comprises a second verification method, in which:
a spectral value that is missing from the measurement spectrum in the reference wavelength that lies outside the measured wavelength range is determined by extrapolation using two or more spectral values contained in the measurement spectrum at different wavelengths, wherein the different wavelengths lie in an edge range of the measured wavelength range that faces the reference wavelength lying outside the measured wavelength range,
a difference between the spectral value determined by extrapolation for the reference wavelength and the reference value is determined, and
the existence of an offset with a size corresponding to the value of the difference is established if the difference is greater than a predetermined tolerance.

Developments of the second variant consist in the fact that
a) the measured wavelength range comprises wavelengths in the ultraviolet and/or visual range and the reference wavelength lying outside this measured wavelength range is much larger than the wavelengths in the measured wavelength range,
b) the measured wavelength range comprises wavelengths in the ultraviolet range and the reference wavelength lying outside this measured wavelength range lies in the visual range and/or is greater than or equal to 380 nm or greater than or equal to 500 nm,
c) the measured wavelength range comprises wavelengths in the visual range and the reference wavelength lying outside this measured wavelength range lies in the near-infrared range and/or is greater than or equal to 800 nm or even greater than or equal to 830 nm, or
d) the measured wavelength range comprises wavelengths in the near-infrared range and the reference wavelength lying outside this measured wavelength range is much smaller than the wavelengths in the measured wavelength range, lies in the visual range and/or is greater than or equal to 380 nm or greater than or equal to 500 nm.

According to a further development of the first variant, the reference value expected in the absence of interferences in the reference wavelength is determined in advance using spectral values ascertained by extrapolation for reference spectra recorded by the spectrometric sensor in the absence of interferences in the reference wavelength.

A third variant provides that
the predetermined spectral range comprises a subrange of the measured wavelength range,
the reference comprises a reference progression of the spectral values expected in the subrange in the absence of interferences, and
the verification method comprises a third verification method, in which:
a wavelength-dependent auxiliary function defined in the subrange is set up, which corresponds to the sum of an offset variable and a product of a scaling factor and the reference progression,
the pair of values of the offset variable and the scaling factor, for which a difference between the auxiliary function and the particular measurement spectrum within the subrange is minimal, is determined, and
the existence of an offset with a size corresponding to the value of the offset variable minimizing the difference is established if the value of the offset variable minimizing the difference is greater than a predetermined tolerance.

A development of the third variant consists in the fact that
the measured wavelength range:
a) comprises wavelengths in the ultraviolet and visual ranges or wavelengths in the visual range and the subrange is a long-wave edge wavelength range of this measured wavelength range and/or comprises wavelengths greater than or equal to 380 nm or greater than or equal to 500 nm, or
b) comprises wavelengths in the visual and/or infrared range, and the subrange (A2R) is a long-wave edge wavelength range, a short-wave edge wavelength range or a middle wavelength subrange of the measured wavelength range (A2m) and/or comprises wavelengths greater than or equal to 380 nm, greater than or equal to 500 nm, greater than or equal to 800 nm or greater than or equal to 830 nm, and/or
the reference progression expected in the subrange of the measured wavelength range in the absence of interferences is determined in advance on the basis of spectral progressions for reference spectra recorded in the subrange by the spectrometric sensor in the absence of interferences.

According to at least one embodiment, measured values for a concentration of an analyte contained in the medium, a nitrite content of the medium, a nitrate content of the medium, a chemical oxygen demand of the medium, a biological oxygen demand of the medium, a color of the medium, an organic carbon content of the medium, an organic carbon content of the medium dissolved in the medium and/or a degree of turbidity of the medium are determined on the basis of spectral values for the medium spectra.

Furthermore, the present disclosure comprises a measuring device for performing the measuring method according to the present disclosure, which:
is designed as a spectrometric sensor or comprises a spectrometric sensor, wherein the spectrometric sensor is designed to continuously determine and provide measurement spectra of the medium in the predetermined measured wavelength range, and
comprises an evaluation apparatus, wherein the evaluation apparatus:
comprises a signal processing apparatus that is designed to determine the medium spectra on the basis of the measurement spectra determined by the spectrometric sensor, and
comprises a measurement value determination apparatus that is designed to determine and provide the measured values for the or each measurement variable on the basis of the medium spectra.

According to a further development, the measuring device comprises an output apparatus connected to the evaluation apparatus, wherein the output apparatus:
comprises an interface via which the measured values can be read out, output and/or transmitted wirelessly and/or via wires in the form of data and/or signals,
comprises a display device for displaying the measured values, and/or
comprises a display element that indicates when the existence of an offset has been determined using the verification method, and/or which indicates whether or not the measurement spectrum, on the basis of which the particular measured value was determined, contains an offset.

Furthermore, the present disclosure comprises a computer program comprising computer-readable program code elements that, when executed on a computer, prompt the computer to use the measurement spectra determined by the spectrometric sensor to carry out the method steps of the measuring method that are carried out in the measuring method according to the present disclosure on the basis of the measurement spectra or at least to determine the medium spectra and to provide the medium spectra and/or the measured values of the or each measurement variable.

Furthermore, the present disclosure also comprises a computer program product comprising the above-mentioned computer program and at least one computer-readable medium on which at least the computer program is stored.

### BRIEF DESCRIPTION OF THE DRA WINGS

The present disclosure and its advantages will now be explained in detail using the figures in the drawing, which show several examples of embodiments. The same elements are indicated by the same reference numbers in the figures.

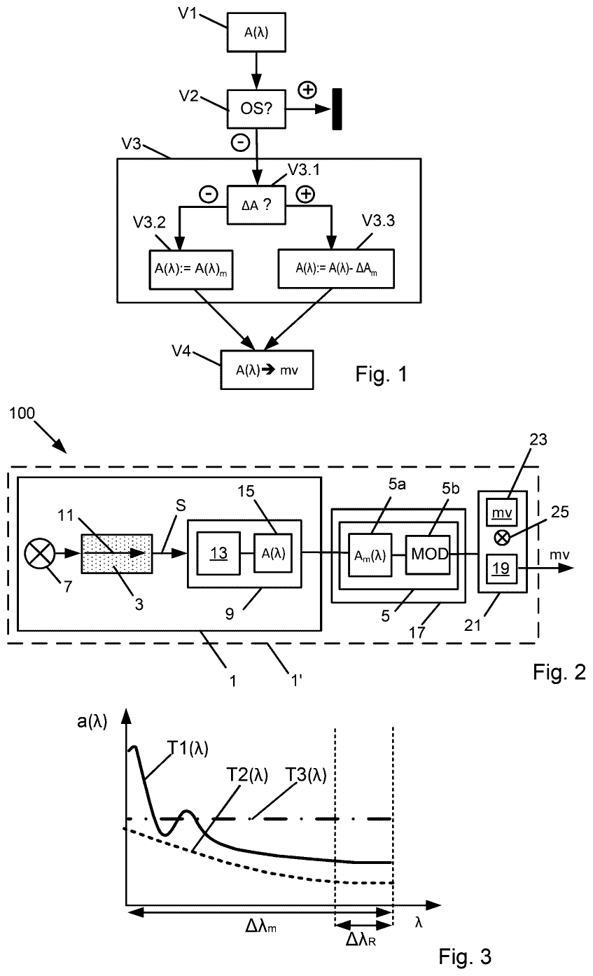

FIG. 1 shows a flowchart of a measuring method;

FIG. 2 shows a measuring device for performing the measuring method shown in FIG. 1;

FIG. 3 shows subspectra contained in a measurement spectrum;

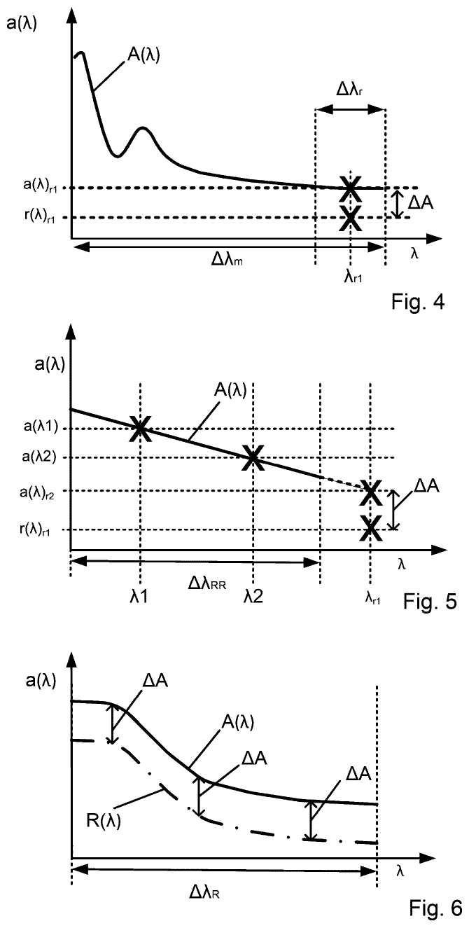

FIG. 4 shows a method for offset determination using a reference value that lies within a measured wavelength range;

FIG. 5 shows a method for offset determination using a reference value that lies outside a measured wavelength range; and

FIG. 6 shows a method for offset determination using a reference progression.

### DETAILED DESCRIPTION

The present disclosure comprises a spectrometric measuring method for determining at least one measurement variable of a medium, as well as a measuring device for performing this method. A flowchart for the measuring method is shown in FIG. 1. An exemplary embodiment of the measuring device 100 for performing the measuring method shown in FIG. 1 is shown in FIG. 2.

As shown in FIG. 2, the measuring device 100 comprises a spectrometric sensor 1, which is designed to repeatedly determine and provide measurement spectra A(λ) of the medium 3 in a predetermined measured wavelength range Δλₘ, and an evaluation apparatus 5, which is designed to determine and provide measured values mv for the measurement variable(s) on the basis of the measurement spectra A(λ) using the method shown in FIG. 1.

In the exemplary embodiment shown in FIG. 2, the spectrometric sensor 1 is designed as a sensor operating in transmission. The spectrometric sensor 1 shown comprises a radiation source 7, which radiates radiation through the medium 3 during measurement operation, and a spectrometric unit 9, which receives measurement radiation S emanating from the medium 3. The radiation interacts with the medium 3 along an optical path 11 that passes through the medium 3 in this case, during which interaction a component of the radiation transmitted from the radiation source 7, which component is dependent on the wavelength-dependent absorption properties of the medium 3, is absorbed. In turbid media 3, a further interaction regularly also takes place in which a component of the radiation transmitted from the radiation source 7 into the medium 3, which component is dependent on the turbidity of the medium 3, is scattered in a direction other than the optical path 11. This component regularly has a significantly lower wavelength dependence than the component absorbed by the medium 3 along the optical path 11. Each component causes a reduction in the radiation intensity received by the spectrometric unit 9.

The spectrometric unit 9 shown here by way of example comprises a detector 13 that receives the measurement radiation S and a measuring electronics unit 15 connected to the detector 13, which determines the measurement spectra A(λ) using the radiation intensities of the measurement radiation S measured by the detector 13 at different wavelengths λᵢ. The measurement spectra A(λ) can be determined, for example, as intensity spectra provided by the measuring electronics unit 15, for example in the form of raw digital or analog spectrometric signals, which comprise pairs of spectral values corresponding to the intensity I_{gem}(λᵢ) measured for the particular wavelength λᵢ and the associated wavelength λᵢ. Alternatively, the measuring electronics unit 15 is designed to determine the measurement spectra A(λ) as absorption spectra. In this case, the spectral values a(λᵢ) of the measurement spectra A(λ), which spectral values each occur for a specific wavelength λᵢ and are formed as absorption values, are, for example, each determined in accordance with: a(λᵢ):=−Log [I_{gem}(λᵢ)/I₀(λᵢ)] as the logarithm of the ratio of the radiation intensity I₀(λᵢ) entering the medium 3 at this wavelength λᵢ to the intensity I_{gem}(λᵢ) of the measurement radiation S impinging on the detector 13 measured by the detector 13 at this wavelength λᵢ.

The present disclosure is not limited to the spectrometric sensor 1 shown in FIG. 2, but can also be used analogously in conjunction with other spectrometric sensors known from the prior art. Likewise, it can also be used in conjunction with spectrometric sensors without their own radiation source, which receive measurement radiation S along a received signal path, and determine and provide the associated measurement spectra A(λ), which in this case are also formed, for example, as intensity or absorption spectra.

In the example shown in FIG. 2, the evaluation apparatus 5 is arranged, for example, in a device 17 connected to the spectrometric sensor 1, such as a transmitter or a measuring transducer. Alternatively, however, the measuring device 100 as a whole can also be designed as a spectrometric sensor 1′ shown as an alternative by dashed lines in FIG. 2, which comprises the evaluation apparatus 5.

The measuring method described in detail below, and of course analogously the measuring device 100 performing the measuring method, can be used in a number of different applications in which interferences such as air bubbles, gas bubbles or macroscopic particles can sporadically occur in the medium 3. Examples include breweries, water monitoring facilities, wastewater treatment plants, such as municipal wastewater treatment plants or industrial wastewater treatment plants used in certain industries, laundries, or plants carrying drinking water. In these applications, the measurement method shown in FIG. 1 is used to detect interferences in the medium 3, whose dimensions are larger than the wavelengths λᵢ contained in the measured wavelength range Δλₘᵢ, and their adverse effects on the measured values mv compensated for accordingly.

The measured wavelength range Δλₘ of the spectrometric sensor 1, 1′ comprises, depending on the type of measurement variable(s) to be measured, e.g. wavelengths in the ultraviolet range, in the visual range and/or in the near-infrared range, such as wavelengths in a wavelength range from 190 nm to 2500 nm or in a section of this wavelength range.

Interferences occurring in the medium 3, such as air or gas bubbles and/or macroscopic particles, usually have dimensions in the millimeter range or at least in the micrometer range, which are significantly larger than the wavelengths λᵢ in the measured wavelength range Δλₘ. In this respect, macroscopic particles are understood to be solid bodies, such as small stones or lumps of sand, whose dimensions are larger than the dimensions of solids suspended in the medium 3, which may be responsible for the turbidity of the medium 3 and are generally microscopically small.

The measuring method shown in FIG. 1 comprises a first method step V1, in which a spectrometric sensor, such as the spectrometric sensor 1, 1′ of the measuring device 100 shown in FIG. 2, continuously determines measurement spectra A(λ) of the medium 3 in the predetermined measured wavelength range Δζₘ.

In a second method step V2, the continuously determined measurement spectra A(λ) are used to identify and discard those measurement spectra A(λ) during the recording of which an optical saturation OS of the spectrometric sensor 1, 1′ has occurred.

In conjunction with measurement spectra A(λ) in the form of absorption spectra, optical saturation occurs if the absorption occurring along the optical path 11 exceeds an upper limit value for measurable absorption values, above which further additional absorption no longer results in an increase in the measurement spectral values a(λ) that can be resolved using measurements. In conjunction with measurement spectra A(λ) in the form of intensity spectra, optical saturation occurs if the intensity of the measurement radiation S becomes so low that the measurement spectral values formed as intensity values in this case fall below a lower limit value for measurable intensity values, below which a further additional decrease in intensity no longer causes a reduction in the measured intensity values that can be resolved using measurements. In both cases, the particular limit value is a constant or even wavelength-dependent property of the spectrometric sensor 1, 1′, which can in each case be measured experimentally or determined numerically for a wide variety of spectrometric sensors.

Accordingly, in conjunction with measurement spectra A(λ) designed as intensity spectra, for example, the second method step V2 proceeds such that the occurrence of optical saturation OS is established if at least one or the smallest of the spectral values of the particular measurement spectrum A(λ) falls below the associated lower limit value. Analogously, in conjunction with measurement spectra A(λ) in the form of absorption spectra, for example, the second method step V2 proceeds such that the occurrence of optical saturation OS is established if at least one or the largest of the spectral values a(λᵢ) of the particular measurement spectrum A(λ) exceeds the associated upper limit value.

In order to be able to determine reliable measured values mv of the or each measurement variable both in the presence and in the absence of interferences, in a third method step V3 a medium spectrum Aₘ(λ), which represents the spectral properties of the medium 3, is determined for at least one or each measurement spectrum A(λ) remaining after the second method step V2 has been carried out.

The third method step V3 is based on the consideration that in each measurement spectrum A(λ), a plurality of effects are superimposed and each measurement spectrum A(λ) can be described, at least approximately, as a sum or as a weighted sum of subspectra assigned to the individual effects. These subspectra comprise a first subspectrum T1(λ) corresponding to the wavelength-dependent absorption in the medium 3, and possibly also a second subspectrum T2(λ) corresponding to the scattering caused by the turbidity of the medium 3. In the presence of an interference in the medium 3, such as at least one air bubble entering the optical path 11 in the medium 3, at least one gas bubble entering the optical path 11 in the medium 3, and/or at least one macroscopic particle entering the optical path 11 in the medium 3, the subspectra additionally comprise a third subspectrum T3(λ) caused by the disturbance. Examples of absorption spectra for all three subspectra T1(λ), T2(λ), T3(λ) are shown in FIG. 3. The measured wavelength range λₘ shown by way of example in FIG. 3 comprises wavelengths λᵢ in the ultraviolet range and in the visual range.

As can be seen from FIG. 3, the first subspectrum T1(λ) that corresponds to the wavelength-dependent absorption in the medium 3 and is within the measured wavelength range Δλₘ shown by way of example in FIG. 3 has a wavelength dependence that corresponds to the wavelength-dependent absorption coefficient of the medium 3 and is usually not linear across much of the measured wavelength range Δλₘ, which decreases sharply toward the long-wave edge of the measured wavelength range Δλₘ shown in FIG. 3. In comparison, the second subspectrum T2(λ), which is caused by the turbidity or scattering of usually microscopically small suspended solids, regularly has a substantially continuous progression, the wavelength dependence of which also decreases sharply toward the long-wave edge of the measured wavelength range Δλₘ shown in FIG. 3.

The spectral progression of the third subspectrum T3(λ) caused by the interference is dependent on the interactions between the radiation and the particular interference. These interactions substantially consist in some of the radiation being absorbed in the interference and/or some of the radiation being reflected and/or scattered by the interference.

Gaseous interferences have a significantly lower optical density than the liquid medium

3. Accordingly, the partial length of the optical path 11 passing through gaseous interferences, such as air bubbles and/or gas bubbles, is usually too short for the radiation component absorbed in these interferences to be able to lead to the third subspectrum T3(λ) being substantially dependent on the wavelength. On the premise that the gaseous interferences have dimensions that are significantly larger than the wavelengths λᵢ in the measured wavelength range Δλₘ, the radiation component reflected or scattered at these interferences does not lead to the third subspectrum T3(λ) being substantially dependent on the wavelength either.

Interferences in the form of solids, such as macroscopic particles, have a significantly higher optical density than the liquid medium 3. This leads to some of the radiation within the entire measured wavelength range Δλₘ impinging on these interferences along the optical path 11 being almost completely absorbed and some reflected and/or scattered. The almost complete absorption in the entire measured wavelength range Δλₘprovides an at least approximately constant contribution to the third subspectrum T3(λ) within the entire measured wavelength range Δλₘ. On the premise that the macroscopic particles have dimensions that are significantly larger than the wavelengths Aj in the measured wavelength range Δλₘ, the radiation component scattered and/or reflected by these interferences does not lead to the third subspectrum T3(λ) being substantially dependent on the wavelength either.

Accordingly, the third subspectrum T3(λ) has a spectral progression that is at least approximately equal to a constant offset ΔA for interferences that include air bubbles, gas bubbles and/or macroscopic particles entering the beam path 11 in the medium 3, the dimensions of which are larger than the wavelengths λᵢ in the measured wavelength range Δλₘ.

The medium spectra Aₘ(λ) representing the spectral properties of the medium 3 can be described at least approximately as the sum of the first subspectrum T1(λ) and the second subspectrum T2(λ). The third subspectrum T3(λ) is additionally superimposed by this sum spectrum caused by the medium 3 in the measurement spectra A(λ) in the presence of interferences, which third subspectrum, on the premise that the interferences have dimensions that are significantly larger than the wavelengths λᵢ in the measured wavelength range Δλₘ, corresponds at least approximately to a constant offset ΔA.

Based on this knowledge, in a first sub-step V3.1 in which the determination of the associated medium spectrum Aₘ(λ) is carried out in the third method step V3 for the or each remaining measurement spectrum A(λ), a verification method is carried out in which the particular measurement spectrum A(λ) and a previously determined reference for a spectrum property expected in the absence of interferences within a predetermined spectral range comprising at least one reference wavelength λᵣᵢ are used to verify whether or not the particular measurement spectrum A(λ) contains an offset ΔAcaused by interference occurring in the medium 3 while recording the corresponding measurement spectrum A(λ). If an offset ΔA exists, its size is preferably simultaneously also determined in the first sub-step V3.1, e.g. in the form of an offset value.

In the verification method, a range in which the absorption coefficient of the medium 3 varies by less than a predetermined spectral variance depending on the wavelength and/or is below a predetermined limit value is used as the predetermined spectral range.

The spectral variance is calculated, for example, using the sum of the squares of the differences between the values for the absorption coefficient in the wavelengths within the spectral range and the mean of these values within the spectral range.

As can be seen from the first subspectrum T1(λ) shown in FIG. 3 and the second subspectrum T2(λ) shown in FIG. 3, both the wavelength dependence of the absorption coefficient of the medium 3 and the value thereof in a long-wave subrange of the measured wavelength range Δλₘ comprising wavelengths in the ultraviolet and visual ranges in FIG. 3 continues to decrease as the wavelength increases. In the case of these wavelengths, the influence of any turbidity of the medium 3 is simultaneously also small and has no or only a very little wavelength dependence.

Accordingly, a spectral range that comprises at least one wavelength in the visual range, such as at least one wavelength in the range from 380 nm to 800 nm, and/or at least one wavelength in the near-infrared range, such as at least one wavelength in the range from 800 nm to 2500 nm, is particularly suitable as the predetermined spectral range. Where the predetermined spectral range lies in relation to the measured wavelength range Δλₘ depends on the size of the measured wavelength range Δλₘ.

A suitable spectral range is, for example, a range that comprises at least one reference wavelength Δλᵣ₁ that lies within a subrange Δλ_{R} of the measured wavelength range Δλₘ, a range corresponding to a subrange Δλ_{R} of the measured wavelength range Δλₘ and/or a range comprising at least one reference wavelength Δλᵣ₂ that lies outside the measured wavelength range Δλₘ. Each subrange Δλ_{R} of the measured wavelength range Δλₘ is, depending on the size of the measured wavelength range Δλₘ, for example a long-wave edge wavelength range, a short-wave edge wavelength range or a middle wavelength subrange of the measured wavelength range Δλₘ.

In conjunction with predetermined spectral ranges comprising at least one single reference wavelength λr₁, λr₂, the reference for the spectrum property expected in the absence of interferences comprises, for example, a reference value r(λᵣ₁), r(λᵣ₂) for the spectral value a (λᵣ₁), a(λᵣ₂) expected in the absence of interferences for the corresponding reference wavelength λᵣ₁, λᵣ₁.

FIG. 4 shows, as an exemplary embodiment thereof, an example of a measurement spectrum A(λ) recorded in the measured wavelength range λₘ shown in FIG. 3 in the presence of an interference, a spectral value a(λᵣ₁) of the measurement spectrum A(λ) for the reference wavelength λr₁ that lies within the subrange Δλ_{R} of the measured wavelength range Δλₘ in this case, and the associated reference value r(λᵣ₁) expected in the absence of interferences in the reference wavelength λᵣ₁.

In conjunction with the measured wavelength range ΔΔλₘ shown as an example in FIGS. 3 and 4 and comprising wavelengths λᵢ in the ultraviolet and visual ranges, the subrange Δλ_{R} is preferably a long-wave edge wavelength range of the measured wavelength range Δλₘ. Analogously, the subrange Δλₘ is preferably also a long-wave edge wavelength range of the measured wavelength range Δλₘ for measured wavelength ranges Δλₘ comprising wavelengths λ in the visual range. In both cases, a wavelength greater than or equal to 380 nm or even greater than or equal to 500 nm is suitable as the reference wavelength λr₁ that lies within the measured wavelength range Δλₘ, for example.

In conjunction with measured wavelength ranges Δλₘ, which comprise wavelengths in the visual and/or near-infrared range, the subrange Δλ_{R} is, for example, a long-wave edge wavelength range, a short-wave edge wavelength range or a middle wavelength range of the measured wavelength range ΔΔₘ, depending on the size of the measured wavelength ranges Δλₘ. In these cases, a wavelength greater than or equal to 380 nm, greater than or equal to 500 nm, greater than or equal to 800 nm, or greater than or equal to 830 nm is suitable as the reference wavelength λr₁ that lies within the measured wavelength range Δλₘ, depending on the size of the measured wavelength range Δλₘ.

Because the reference wavelength λᵣ₁ lies within the measured wavelength range Δλᵣ₁, the reference value r(λᵣ₁) expected in the absence of interferences in the reference wavelength λᵣ₁ is, for example, determined in advance using spectral values a(λᵣ₁) for reference spectra recorded by the spectrometric sensor 1, 1′ in the absence of interferences in the reference wavelength λᵣ₁.

In this exemplary embodiment, method step V3.1 proceeds such that a difference between the spectral value a(λᵣ₁) of the particular measurement spectrum A(λ) at the reference wavelength λᵣ₁ and the reference value r(λᵣ₁) and the existence of an offset ΔA is established if the difference is greater than a predetermined tolerance. The tolerance is, for example, a tolerance that is predetermined on the basis of the sensor-specific measurement accuracy of the spectral values a(λ) for the measurement spectra A(λ). In this embodiment, the size of the offset ΔA is given by the value of the difference and is determined according to: ΔA:=a(λᵣ₁)−r(λᵣ₁), for example.

The embodiment shown in FIG. 4 is particularly advantageous in applications in which the spectral values a(λ) of measurement spectra A(λ) recorded in the absence of interferences are at least approximately constant in the subrange Δλ_{R} of the measured wavelength range Δλₘ.

FIG. 5 shows, as a further exemplary embodiment, part of a measurement spectrum A(λ) recorded in the presence of an interference together with a reference value r(λᵣ₂) expected in the absence of interferences in a reference wavelength λᵣ₂ that lies outside the measurement wavelength range Δλₘ in this case. In conjunction with a measured wavelength range Δλₘ, which comprises wavelengths λᵢ in the ultraviolet and/or visual range, the reference wavelength λᵣ₂ that lies outside the measured wavelength range Δλₘ is much larger than the wavelengths λᵢ contained in the measured wavelength range Δλₘ. In this respect, a suitable reference wavelength λᵣ₂ that lies outside the measured wavelength range Δλₘ for measured wavelength ranges Δλₘ that comprise wavelengths λᵢ in the ultraviolet range is, for example, a wavelength in the visual range, such as a wavelength greater than or equal to 380 nm or even greater than or equal to 500 nm. For measured wavelength ranges Δλₘ that comprise wavelengths λᵢ in the visual range, a suitable reference wavelength λᵣ₂ that lies outside the measured wavelength range Δλₘ is, for example, a wavelength in the near-infrared range, such as a wavelength greater than or equal to 800 nm or even greater than or equal to 830 nm.

In conjunction with measured wavelength ranges Δλₘ that comprise wavelengths λᵢ in the near-infrared range, the reference wavelength λᵣ₂ that lies outside the measurement wavelength range Δλₘ is, for example, much smaller than the wavelengths λᵢ in the measured wavelength range Δλₘ. In this respect, a suitable reference wavelength λᵣ₂ that lies outside the measured wavelength range Δλₘ for these measured wavelength ranges Δλₘ is, for example, a wavelength in the visual range, such as a wavelength greater than or equal to 380 nm or even greater than or equal to 500 nm.

In the exemplary embodiment shown in FIG. 5, method step V3.1 proceeds, for example, such that the spectral value a(λᵣ₂) missing from the measurement spectrum A(λ) for the reference wavelength λᵣ₂ that lies outside the measured wavelength range Δλₘ is determined by extrapolation using two or more spectral values a(λ1), a(λ2) in the measurement spectrum A(λ) for different wavelengths 21, 22. As shown in FIG. 5, spectral values a(λ1), a(λ2) that occur at wavelengths 21, λ2 that lie in an edge range Δλ_{RR} of the measured wavelength range Δλₘ facing the reference wavelength λr₂ that lies outside the measured wavelength range Δλₘ are preferably used for this purpose. Using the spectral values a(λ1), a(λ2) contained in the measurement spectrum A(λ) and the associated wavelengths λ1, λ2, extrapolation is carried out by a polynomial, e.g. a polynomial of degree one or two. Alternatively, extrapolation can be carried out using an exponential function.

In this exemplary embodiment, the reference value r(λᵣ₂) expected in the absence of interferences in the reference wavelength λᵣ₂ is, for example, determined in advance using spectral values a(λᵣ₂) established by extrapolation for reference spectra recorded by the spectrometric sensor 1, 1′in the absence of interferences in the reference wavelength λᵣ₂.

Analogous to the previously described embodiment, in this embodiment, too, the difference between the spectral value a(λᵣ₂)—established here by extrapolation using the measurement spectrum A(λ)—for the reference wavelength λr₂ and the reference value r(λᵣ₂) is determined and the existence of an offset ΔA is established if the difference is greater than the predetermined tolerance. The size of the offset ΔA is given by the value of the difference and is calculated according to: ΔA:=a(λᵣ₂)−r(λᵣ₂), for example.

This embodiment is advantageous in particular in applications where the spectral values a(λ) for measurement spectra A(λ) recorded in the absence of interferences in the edge range Δλ_{RR} of the measured wavelength range Aam facing the reference wavelength λr₂ that lies outside the measured wavelength Δλₘ can be described, at least approximately, by a straight line. FIG. 6 shows, as a further exemplary embodiment, part of a measurement spectrum A(λ) recorded in the presence of interference in a subrange Δλ_{R} of the measured wavelength range Δλₘ. In this exemplary embodiment, the spectral range used to check for interferences comprises the subrange Δλ_{R} of the measured wavelength range Δλₘ and the reference R comprises a reference curve R(λ) of the spectral values that is expected in the subrange Δλ_{R} in the absence of interferences.

Depending on the size of the measured wavelength range Δλₘ, the subrange Δλ_{R} is also formed in this case, for example, in the manner previously described in connection with the exemplary embodiment shown in FIG. 4. Accordingly, the subrange Δλ_{R} is, in conjunction with measured wavelength ranges Δλₘ that comprise wavelengths in the ultraviolet and visual ranges or that comprise wavelengths in the visual range, preferably a long-wave edge wavelength range of the corresponding measured wavelength range Δλₘ and/or a range comprising wavelengths greater than or equal to 380 nm or greater than or equal to 500 nm.

In conjunction with measured wavelength ranges Δλₘ, which comprise wavelengths in the visual and/or infrared range, the subrange Δλ_{R} is, depending on the size of the measured wavelength range Δλₘ, for example a long-wave edge wavelength range, a short-wave edge wavelength range or a middle wavelength subrange of the measured wavelength range Δλₘ and/or a range comprising wavelengths greater than or equal to 380 nm, greater than or equal to 500 nm, greater than or equal to 800 nm, or greater than or equal to 830 nm.

Since the subrange Δλ_{R} lies within the measured wavelength range Δλₘ, the reference progression R(λ) expected in the absence of interferences in this wavelength range is determined in advance, for example on the basis of the spectral progressions of the spectral values for reference spectra recorded by the spectrometric sensor 1, 1′ in the absence of interferences in the subrange Δλ_{R}.

In the exemplary embodiment shown in FIG. 6, in method step 3.1. a wavelength-dependent auxiliary function H(λ), such as H(λ):=U+G*R(λ) that is defined in the subrange Δλ_{R} is set up, which corresponds to the sum of an offset variable U and the product of a scaling factor G and the spectral reference progression R(λ). The value pair [Uₘᵢₙ; Gₘᵢₙ] of the offset variable U and the scaling factor G is then determined, wherein the difference between the auxiliary function H(λ) and the particular measurement spectrum A(λ) within the subrange Δλ_{R} is minimal. In order to determine the value pair [Uₘᵢₙ; Gₘᵢₙ] of the offset variable U and the scaling factor G that minimizes the difference, the least squares method is used, for example. Alternatively, other minimization methods and/or curve fitting methods known from the prior art can, however, also be used.

Analogous to the previously described exemplary embodiments, this embodiment also proceeds in such a way that the existence of an offset ΔA is established when the value Uₘᵢₙ of the offset variable U that minimizes the difference is greater than the predetermined tolerance. The size of the offset ΔA here is given by the value Uₘᵢₙ of the offset variable U that minimizes the difference and is determined, for example, according to: ΔA:=Uₘᵢₙ.

This embodiment is particularly advantageous in applications in which the spectral values a(λ) of measurement spectra A(λ) recorded in the absence of interferences within the subrange Δλ_{R} of the measured wavelength range Alm have a certain degree of non-linear wavelength dependence.

Following the verification method carried out in the first sub-step V3.1, the medium spectrum Aₘ(λ) is determined for each verified measurement spectrum A(λ). As shown in FIG. 1, a distinction is then made as to whether the particular measurement spectrum A(λ) has an offset ΔA or not. For measurement spectra A(λ) that do not have an offset ΔA, the associated medium spectrum Aₘ(λ) is determined in a second sub-step V3.2 such that it equals the measurement spectrum A(λ). For measurement spectra A(λ) that have an offset ΔA, a difference spectrum is determined in a third sub-step V3.3 by subtracting the offset ΔA previously determined according to size from the measurement spectrum A(λ), and the associated medium spectrum Aₘ(λ) is determined such that it equals the difference spectrum determined in this way.

Lastly, in method step V4, the spectral values of the medium spectra Aₘ(λ) determined in this way are used to determine measured values mv for the measurement variable(s) to be measured, such as a concentration of an analyte in the medium 3, a nitrite content of the medium 3, a nitrate content of the medium 3, a chemical oxygen demand of the medium 3, a biological oxygen demand of the medium 3, a color of the medium 3, an organic carbon content of the medium 3, an organic carbon content of the medium 3 dissolved in the medium 3 and/or the turbidity of the medium 3.

To determine the measured values mv, depending on the measurement variable, methods known from the prior art are used, for example, by which the measured values of the particular measurement variable are determined using measurement spectra in the prior art. For example, measured values mv for the turbidity of the medium 3 are determined using a specific integral total value that is determined on the basis of the spectral values in the entire measured wavelength range Δλₘ or using spectral values for the medium spectra Aₘ(λ) that occur where there are one or more specific wavelengths λ. Other methods known from the prior art comprise, inter alia, MOD calculation rules, also referred to among experts as chemometric models, with which measured values mv for measurement variables, such as the concentration of an analyte in the medium 3, the nitrite content, the nitrate content, the organic carbon content, the organic carbon content dissolved in the medium 3, as well as the chemical and/or biological oxygen demand of the medium 3 can be calculated using the spectral values for measurement spectra. Since the medium spectra Aₘ(λ) are equal to the measurement spectra A(λ) in the absence of interferences and correspond to measurement spectra A(λ) compensated for with respect to the interference in the presence of interferences, these methods can be easily adopted from the prior art and applied in the fourth method step V4.

The measuring method shown in FIG. 1 is designed as a computer-implemented method, for example. In this respect, the present disclosure also comprises a computer program that comprises computer-readable program code elements that, when executed on a computer, prompt the computer to use the measurement spectra A(λ) determined by the spectrometric sensor 1, 1′ to carry out method steps V2 to V4 shown in FIG. 1 and carried out on the basis of measurement spectra A(λ), or at least the method steps V2 to V3 carried out on the basis of measurement spectra A(λ) to determine the medium spectra Aₘ(λ) and provide the medium spectra Aₘ(λ) and/or measured values mv for the or each measurement variable. Furthermore, the present disclosure comprises a computer program product having at least one computer-readable medium, on which at least the computer program is stored.

In measuring devices, such as the measuring device 100 shown in FIG. 2, for performing the method shown in FIG. 1, the evaluation apparatus 5 comprises, for example, a signal processing apparatus 5a that is designed to determine the associated medium spectra Aₘ(λ) on the basis of the measurement spectra A(λ) determined by the spectrometric sensor 1, 1′ in the above-described manner, and a measured value determination apparatus 5b, which is designed to use the medium spectra Aₘ(λ) to determine and provide the measured values mv for the or each measurement variable.

The signal processing apparatus 5a comprises, for example, a data processing device, such as a computer or a microprocessor, and a computer program stored in a memory and executable the data processing device, by which the medium spectra Aₘ(λ) are determined using the measurement spectra A(λ). Analogously, the measured value determination apparatus 5b comprises, for example, a data processing device, such as a computer or a microprocessor, and a computer program stored in a memory and executable by the data processing device, by which the measured values mv are determined using the medium spectra Aₘ(λ).

The measured values mv can each be read out, output and/or transmitted to a unit at a higher level than the measuring apparatus 100, such as a control room, a process control system, a distributed control system or a programmable logic controller, wirelessly and/or via wires, for example in the form of data or signals via an interface 19 of an output apparatus 21 of the measuring device 100 connected to the evaluation apparatus 5. Alternatively or additionally, the output apparatus 21 comprises, for example, a display device 23, such as a display, for displaying the measured values mv and/or a display element 25, such as a light-emitting diode, which indicates when the existence of an offset ΔA has been established using the verification method and/or which indicates whether or not the measurement spectrum A(λ), on the basis of which the particular measured value mv was determined, contains an offset ΔA.

We claim:

1. A spectroscopic measuring method for measuring at least one measurement variable of a liquid medium in which interferences due to air bubbles, gas bubbles, and/or particles whose dimensions are larger than wavelengths within a predetermined measured wavelength range can occur, the measuring method comprising:
continuously recording and determining measurement spectra of the medium within the measured wavelength range using a spectrometric sensor;
identifying and discarding measurement spectra in which optical saturation of the spectrometric sensor occurred during the recording of the corresponding measurement spectra;
determining a medium spectrum for at least one of the remaining measurement spectra via a verification method, the verification method comprising:
verifying whether a particular measurement spectrum of the remaining measurement spectra includes an offset caused by an interference based on a predetermined reference for a spectrum property expected in an absence of the interference within a predetermined spectral range, in which an absorption coefficient of the medium varies by less than a predetermined spectral variance depending on wavelength and/or is below a predetermined limit value;
when the particular measurement spectrum includes the offset, determining an offset value of the offset; and
determining the medium spectrum such that the medium spectrum is equal to the particular measurement spectrum when the particular measurement spectrum does not contain an offset or is equal to a difference spectrum determined by subtracting the offset value from the particular measurement spectrum when the medium includes the offset; and
determining a measurement value of the at least one measurement variable using the medium spectrum.

2. The measuring method according to claim 1, wherein:
the measured wavelength range comprises at least one wavelength selected from the ultraviolet range, the visual range, the near-infrared range, and a range of 190 nm to 2500 nm; and
the spectral range comprises at least one wavelength selected from the visual range, the range of 380 nm to 800 nm, the near-infrared range, and the range of 800 nm to 2500 nm.

3. The measuring method according to claim 1, wherein:
the predetermined spectral range comprises a reference wavelength that is within a subrange of the measured wavelength range;
the reference wavelength comprises a reference value for a spectral value that is expected in the absence of interferences in the reference wavelength; and
the verification method further comprises:
determining a difference between the spectral value of the particular measurement spectrum for the reference wavelength and the reference value; and
establishing the existence of the offset with a size corresponding to the value of the difference if the difference is greater than a predetermined tolerance.

4. The measuring method according to claim 3, in which:
the measured wavelength range comprises a wavelength in the ultraviolet range and a wavelength in the visual range or comprises wavelengths in the visual range, and
the reference wavelength that lies within this measured wavelength range lies within a long-wave edge wavelength range of the measured wavelength range and/or is greater than or equal to 380 nm, or
the measured wavelength range comprises wavelengths in the visual range and/or wavelengths in the near-infrared range, and
the reference wavelength that lies within this measured wavelength range lies in at least one range selected from a long-wave edge wavelength range of the measured wavelength range, a short-wave edge wavelength range of the measured wavelength range, and a middle wavelength range of the measured wavelength range; and/or is greater than or equal to 380 nm.

5. The measuring method according to claim 3, in which the reference value expected for the reference wavelength is determined in advance based on spectral values for reference spectra that are recorded by the spectrometric sensor in the absence of interferences in the reference wavelength.

6. The measuring method according to claim 1, in which:
the predetermined spectral range comprises a reference wavelength that is outside the measured wavelength range; and
the reference wavelength has a reference value for a spectral value that is expected in the absence of interferences in the reference wavelengths that lie outside the measured wavelength range, and
the verification method further comprises:
determining a spectral value that is missing from the measurement spectrum in the reference wavelength that lies outside the measured wavelength range by extrapolation using two or more spectral values contained in the measurement spectrum at different wavelengths, wherein the different wavelengths lie in an edge range of the measured wavelength range towards the reference wavelength;
determining a difference between the spectral value at the reference wavelength by extrapolation such that the reference value is determined; and
establishing the existence of an offset value with a size corresponding to the value of the difference if the difference is greater than a predetermined tolerance.

7. The measuring method according to claim 6, in which:
the measured wavelength range comprises wavelengths in the ultraviolet range and wavelengths in the visual range and the reference wavelength lying outside the measured wavelength range is much larger than the wavelengths in the measured wavelength range; or
the measured wavelength range comprises wavelengths in the ultraviolet range, and the reference wavelength lying outside this measured wavelength range lies in the visual range and/or is greater than or equal to 380 nm; or
the measured wavelength range comprises wavelengths in the visual range, and the reference wavelength lying outside this measured wavelength range lies in the near-infrared range and/or is greater than or equal to 800 nm; or
the measured wavelength range comprises wavelengths in the near-infrared range, and the reference wavelength lying outside this measured wavelength range is much smaller than the wavelengths in the measured wavelength range and lies in the visual range and/or is greater than or equal to 380 nm.

8. The measuring method according to claim 6, in which the reference value expected in the absence of interferences in the reference wavelength is determined in advance based on spectral values, which are established by extrapolation, for reference spectra recorded by the spectrometric sensor in the absence of interferences in the reference wavelength.

9. The measuring method according to claim 1, in which:
the predetermined spectral range comprises a subrange of the measured wavelength range;
the reference spectra comprise a reference progression of the spectral values expected in the subrange in the absence of interferences; and
the verification method comprises a third verification method, comprising the steps of:
defining a wave-length dependent auxiliary function in the subrange, which corresponds to the sum of an offset variable and a product of a scaling factor and the reference progression;
determining the pair of values of the offset variable and the scaling factor, for which a difference between the auxiliary function and the measurement spectrum within the subrange is minimal; and
establishing the existence of an offset with a size corresponding to the offset value minimizing the difference if the value of the offset variable minimizing the difference is greater than a predetermined tolerance.

10. The measuring method according to claim 9, in which the measured wavelength range:
comprises wavelengths in the ultraviolet range and wavelengths in the visual range or wavelengths in the visible range, and the subrange is a long-wave edge wavelength range of this measured wavelength range and/or comprises wavelengths greater than or equal to 380 nm; or
comprises wavelengths in the visual and/or infrared range, and the subrange is selected from a long-wave edge wavelength range of the measured wavelength range, a short-wave edge wavelength range of the measured wavelength range, and a middle wavelength range of the measured wavelength range and/or comprises wavelengths greater than or equal to 380 nm, and/or the reference progression expected in the subrange of the measured wavelength range in the absence of interferences is determined in advance on the basis of spectral progressions of reference spectra recorded in the subrange by the spectrometric sensor in the absence of interferences.

11. The measuring method according to claim 1, in which spectral values for the medium spectra are used to determine measured values for a concentration of an analyte contained in the medium, a nitrite content of the medium, a nitrate content of the medium, a chemical oxygen demand of the medium, a biological oxygen demand of the medium, a color of the medium, an organic carbon content of the medium, an organic carbon content of a medium dissolved in the medium and/or a degree of turbidity of the medium.

12. A measuring device for performing the measuring method according to claim 1, comprising:
a spectrometric sensor, wherein the spectrometric sensor is designed to continuously determine and provide measurement spectra of the medium in the predetermined measured wavelength range; and
an evaluation apparatus, wherein the evaluation apparatus:
comprises a signal processing apparatus that is designed to determine the medium spectra based on the measurement spectra determined by the spectrometric sensor; and
comprises a measured value determination apparatus that is designed to determine and provide the measured values of the or each measurement variable based on the medium spectra.

13. The measuring device according to 12, which comprises an output apparatus connected to the evaluation apparatus, wherein the output apparatus:
comprises an interface, via which the measured values can be outputted and/or transmitted wirelessly and/or via wires in the form of data and/or signals; and/or
comprises a display device for displaying the measured values; and/or
comprises a display element that indicates when the existence of an offset has been determined using the verification method and/or indicates whether the measurement spectrum, based on which the measured value was determined, contains an offset.

14. A computer program comprising computer-readable program code elements that, when executed on a computer, prompt the computer to use the measurement spectra determined by the spectrometric sensor to carry out the method steps of the measuring method according to claim 1 or at least to determine the medium spectra and to provide the medium spectra and/or the measured values of the or each measurement variable.

15. A computer program product comprising a computer program according to claim 14, and at least one computer-readable medium on which at least the computer program is stored.
